(19) United States
(12) Patent Application Publication
(10) Pub. No.: US 2023/0242432 A1
(43) Pub. Date: Aug. 3, 2023

(54) TAILINGS TREATMENT PROCESS

(71) Applicant: Dow Global Technologies LLC, Midland, MI (US)

(72) Inventors: Lizbeth Rostro, Lake Jackson, TX (US); Wu Chen, Lake Jackson, TX (US); Paul A. Gillis, Lake Jackson, TX (US); Michael K. Poindexter, Sugar Land, TX (US)

(21) Appl. No.: 18/004,792

(22) PCT Filed: Jul. 8, 2021
(86) PCT No.: PCT/US2021/040807

§ 371 Date: Jan. 9, 2023

Related U.S. Application Data
(60) Provisional application No. 63/050,957, filed on Jul. 13, 2020.

(51) Int. Cl. C02F 11/147; C02F 11/127

(52) U.S. Cl. CPC C02F 11/147; C02F 11/127; C02F 2103/10

(57) ABSTRACT

Embodiments relate to a continuous process for treating tailings that includes providing tailings for treatment having at least 10 wt % solids, providing a mixing apparatus having a first inlet for feeding the tailings, a second inlet for feeding a non-dispersion liquid flocculant that includes a polyethylene glycol having a weight average molecular weight from 100 g/mol to 2,000 g/mol, and an outlet for a mixture of the tailings and the non-dispersion liquid flocculant, continuously introducing into the mixing apparatus the tailings through the first inlet and the non-dispersion liquid flocculant through the second inlet, and allowing the tailings and the non-dispersion liquid flocculant to mix to from the mixture of the tailings and the non-dispersion liquid flocculant.

### FIELD

Embodiments relate to a treatment process for tailings, e.g., from oil sands and mineral mines, that enables direct addition of a non-dispersion liquid flocculant additive that includes polyethylene glycol, a process for using the treatment process, and tailings treated using the treatment process.

### INTRODUCTION

A flocculation process may be used in the treatment of slurries to separate solids from liquids and/or other solids. Flocculation is a process wherein particles aggregate, perhaps based on the addition of additives such as flocculants, clump together into a floc. The floc may then float to the top of the liquid, settle to the bottom of the liquid, or be readily filtered from the liquid. Flocculation may be used for enhancing dewatering of aqueous waste streams created during the surface mining of oil sands (also known as tailings or mature fine tailings streams), and/or the extraction of valuable components (such as bitumen, phosphate, diamond, gold slimes, mineral sands, tails from zinc, lead, copper, silver, uranium, nickel, iron, or coal). However, due to the rheological properties of the slurries and/or additive streams, difficulties can be encountered with the blending of the additive and the process streams. Therefore, alternatives are sought that at least better enable the addition of additives, that assist the flocculation process, to slurries such as tailings from oil sands and mineral mines, and potentially allow for improved processability and final results.

### SUMMARY

Embodiments may be realized by providing a continuous process for treating tailings. The process comprises providing tailings for treatment having at least 10 wt % solids, based on a total weight of the tailings, providing a mixing apparatus having a first inlet for feeding the tailings, a second inlet for feeding a non-dispersion liquid flocculant that includes a polyethylene glycol having a weight average molecular weight from 100 g/mol to 2,000 g/mol, and an outlet for a mixture of the tailings and the non-dispersion liquid flocculant, continuously introducing into the mixing apparatus the tailings through the first inlet and the non-dispersion liquid flocculant through the second inlet, allowing the tailings and the non-dispersion liquid flocculant to mix to form the mixture of the tailings and the non-dispersion liquid flocculant, continuously removing the mixture of the tailings and non-dispersion liquid flocculant through the outlet to form a treated mixture, and flowing the treated mixture from the mixing apparatus for further treatment or to a disposal area.

### BRIEF DESCRIPTION OF THE DRAWINGS

Features of the embodiments will become more apparent to those of ordinary skill in the art by describing in detail exemplary embodiments thereof with reference to the attached drawings in which:

FIG. 1 illustrates an exemplary flocculation process;

FIG. 2 illustrates the data in Table 1; and

FIG. 3 illustrates the data in Table 2.

### DETAILED DESCRIPTION

Waste material in the form of a slurry, such as tailings from oil sands and mineral mines, may be disposed of by pumping the slurry to a disposal area such as back down the mine, to open mines, to pits, to lagoons, to heaps or to stacks and allowing it to dewater through the actions of sedimentation, drainage, evaporation, and consolidation. For example, the waste material may be transferred along a conduit (such as a pipe or trench) and through an outlet to a deposition area, where the material will then be allowed to dewater and optionally consolidate upon standing.

A flocculation process may be used to treat slurries such as tailings from oil sands or mineral mines. The flocculation process may enable dewatering of the slurry over a period of time extending from hours to years. Dewatering of the treated slurry may allow for reduction of space required in the disposal area for storage of the treated slurries (such as in disposal areas for oil sands). Further, as the solids content of the treated slurries increases, the likelihood of being able to repurpose the storage area may increase. For example, if the solids content of the treated slurries is at least 45 wt % (e.g., at least 55 wt %), the treated slurries may be placed in a disposal area that can be repurposed as a green area that enables the growth of trees, plants, vegetation, etc. A workable solids content for repurposing the disposal area may be reached over an extended period of time, e.g., over period from 1 year to 100 years, 1 year to 50 years, 1 year to 15 years, from 1 year to 10 years, from 1 year to 5 years, etc.

During the flocculation process, the slurry may be fed to a vessel or pipe in which the flocculant is added. The slurry may have a solids content of at least 10 wt % (e.g., from 10 wt % to 80 wt %, from 20 wt % to 80 wt %, from 20 wt % to 60 wt %, 20 wt % to 55 wt %, from 20 wt % to 50 wt %, from 20 wt % to 40 wt %, from 30 wt % to 45 wt %, from 30 wt % to 40 wt %, etc.), based on a total weight of the slurry. The solids may be minerals from oil sands or mines that are suspended in water to form the slurry. The solids may be particles from fine tailings and/or coarse tailings. The particles of the fine tailings may have a mean particle size of less than 45 microns, e.g., 95% of the particles may have a particle size of less than 20 microns. The particles of the coarse tailings may have a mean particle size of greater than 45 microns, e.g., 85% of the particles may have a particle size of greater than 100 microns (may be less than 8,000 microns).

The flocculation process may include the addition of flocculants (additives that assist in enabling dewatering by promoting aggregation of the solids) to the slurry. The flocculants may be added in an effort to increase the dewatering and/or recovery of solids, e.g., interactions between the flocculants and solids in the slurry may enable and/or improve the release of water from the slurry. However, designing a flocculation process that enables the effective addition of flocculants may be challenging, especially when the flocculants are a solid and need to be added as a pre-formed dispersion, a pre-formed solid/liquid solution, as hydrated solid flocculants, and/or need to be added directly using specialized mixing equipment. Accordingly, in exemplary embodiments, the flocculants are a non-dispersion liquid flocculant and may be a non-dispersion, non-solid/liquid solution liquid flocculant and/or be a neat liquid phase flocculant.

In this regard, in some instances it is necessary to form hydrated flocculants as a pre-formed dispersion and/or pre-formed solid/liquid solution of the flocculants, e.g., using a solvent such as water, to allow for effective mixing of the flocculants into the slurry (e.g., tailings stream). For use in a flocculation process this dispersion and/or or solution would be pre-formed prior to addition to the slurry and would have a liquid phase (such as water and/or dispersing agents) and a solid phase (such as a flocculant that is a solid at ambient conditions). By pre-formed dispersion it is meant a dispersion material that is pre-formed prior to addition to the slurry into a continuous liquid phase at ambient conditions and atmospheric pressure, which dispersion is derived from a liquid phase (such as water and/or dispersing agents) and a solid phase (such as a flocculant). By pre-formed solution it is meant a solution material this pre-formed prior to addition to the slurry into a liquid mixture at ambient conditions and atmospheric pressure, which solution is derived from a liquid (such as a solvent) and a solid (such as a flocculant). In other words, the pre-formed dispersion and the pre-formed solution refer to forming a specific type of mixture between a solid and a liquid, which in this instance the solid may be a flocculant. However, as dispersions and solid/liquid solutions are difficult to prepare and may introduce storage concerns, the use of such have many challenges for commercial implementation.

For example, the use of the hydrated solid flocculants provide challenges for commercial implementation, by solid flocculants it is meant flocculant materials that are a solid at room temperature (approximately 23° C.). Exemplary solid flocculants include poly(ethylene oxide)(co)polymer that has a number average molecular weight of at least 100,000 Da (e.g., as discussed in International Publication No. WO2017/205249), high molecular weight polyethylene glycols, alpha olefin polymers, functionalized alpha olefin polymers, alpha olefin copolymers, functionalized alpha olefin copolymers, polyurethane polymers, polyester polymers, acrylic polymers, epoxy polymers, phenolic polymers, silicone polymers, nylon polymers, and HPAM (partially hydrolyzed polyacrylamide) polymers.

The hydration of solid flocculants contributes to higher operational costs because forming the hydrated flocculants is a time consuming process, e.g., may take at least a day to form the hydrated flocculants, and may necessitate a substantial investment in terms of stir tanks, storage tanks, hydration equipment, etc. Also, commercial use of the hydrated solid flocculants may provide processability difficulties because a substantial amount of dewatering may occur soon after the hydrated flocculant is added. This limits how far the treated slurry may be transported, such as from a treatment area to a disposal area, before a substantial amount of dewatering has occurred such that transportation will become more difficult. In addition, if a transportation issue is encountered, such as a pump becomes inoperable, during the delay in resuming operation of the pump, the transportation line may become blocked with dewatered slurry, which may necessitate further downtime for cleanup.

Accordingly, use of hydrated solid flocculants may provide a specific type of floc structure within the treated slurry/tailings that will facilitate the release of water, but which floc structure may provide limitations for commercial use, processability, and final solids content. As such, a flocculation process that minimizes and/or avoids the use of hydrated solid flocculants is sought, while still enabling sufficient mixing and potentially increasing the final solids content to better enable repurposing of the disposal area.

As such it is proposed to use a flocculant that is already in liquid form, in this instance a low molecular weight polyethylene glycol that is storage stable and can be readily added directly as the flocculant (e.g., excluding any hydrated solid flocculants in powder form that are added as part of a dispersion, solution, water soluble additive, or mixture additive) to the slurry to form the treated slurry. By low molecular weight polyethylene glycol (PEG) it is meant a PEG material having a weight average molecular weight from 100 g/mol to 2,000 g/mol (e.g., 100 g/mol to 1,500 g/mol, 100 g/mol to 1,400 g/mol, 100 g/mol to 1,000 g/mol, 100 g/mol to 700 g/mol, 150 g/mol to 700 g/mol, 150 g/mol to 650 g/mol, and 200 g/mol to 600 g/mol). The liquid flocculant may be used in a form that comprises (e.g., consists essentially of) the low molecular weight polyethylene glycol and optionally water. The liquid flocculation may be a mixture of two or more liquids, but is not a dispersion or a solid/liquid solution. The liquid flocculant may be the sole flocculant composition that is added to the tailings for treating the tailings.

The liquid flocculant is not a dispersion, so as to avoid the high costs associated with preparing and storing a dispersion. Further, the liquid flocculant may not be a solid/liquid solution and/or may exclude any hydrated solid flocculants so to avoid the high costs associated with preparing and storing mixtures that include such hydrated solid flocculants and/or the challenge of the high viscosity of resultant liquid dispersion. In other words, if solid additives are excluded then issues with respect to viscosity and/or storage stability may be minimized. Further, use of such a non-dispersion liquid flocculant may allow for reduction in operational costs for commercial use, improved processability, and potentially improved dewatering results. In exemplary embodiments, the non-dispersion liquid flocculant used in the continuous process of treating tailings may account for at least 50%, at least 80% at least 90%, at least 95%, at least 98%, at least 99%, and/or 100% of the total flocculants used. With use of the non-dispersion liquid flocculant, the use of hydrated solid flocculants may be excluded in the process of forming treated tailings.

The flocculation process includes a mixing area that is the mixing apparatus and/or specialty mixer that is the mixing apparatus to allow for direct addition of the non-dispersion liquid flocculant, e.g., various embodiments are possible such as an in-line disperser that may be incorporated into a flocculation process for processing tailings from oil sands or mines. An exemplary specialty mixer may be able to achieve high tip speeds of at least 1 m/s. By tip speed it is meant the linear velocity of the outer edge of rotator. The mixing apparatus may allow for the flocculant and the slurry (such as tailings having a high solids content) to be subjected to shear forces that provide the blending and phase interactions sought to contact the flocculants with the slurry to allow for separation/dewatering of the treated slurry. The mixing apparatus may include one or more agitators, one or more rotors, and/or one or more stators.

The mixing apparatus includes an inlet (i.e., first inlet) for feeding the slurry (tailings). The first inlet may be formed in a housing of the mixing apparatus. The slurry may be stored in a location that is outside the housing and is separate from the location where the flocculants are stored. The slurry is a suspension that is fed to the mixing apparatus with sufficient flow characteristics to allow for mixing with the flocculants.

The mixing apparatus includes a second inlet for feeding the liquid flocculant. The second inlet may be formed in the housing of the mixing apparatus. The second inlet is separate from the first inlet and is positioned to allow for mixing of the liquid flocculant and the slurry in the mixing apparatus. The liquid flocculants may be stored in a location that is outside the housing. In exemplary embodiments, the flocculants may be dropped from a pipe that is outside the housing.

The mixing apparatus includes an outlet, for enabling a mixture of the slurry and flocculants to exit the mixing apparatus. For example, after mixing of the slurry and the flocculants (e.g., by an agitator and/or combination of the rotor and vanes) a treated mixture is formed that will exit the mixing apparatus and be flowed for further processing or to a disposal area to allow for separation/dewatering. For example, the treated mixture may flow from the mixing apparatus to further treatment in a centrifuge, thickener, and/or accelerated dewatering cell and then further flow from the centrifuge, thickener, and/or accelerated dewatering cell to the disposal area. The mixing apparatus may impart momentum to the treated mixture to aid the flow of the material exiting the device. The orientation of the mixing apparatus, with regard to the ground, in the process is not limited, it may be horizontal, vertical, or at any angle in between.

The treated mixture is optionally flowed for further processing and/or eventually to a disposal area for dewatering. In exemplary embodiments, for a period of at least 1000 hours after flowing the treated mixture from the mixing apparatus, the treated mixture has a higher solids content. Accordingly, use of the mixing apparatus and the flocculant may increase the likelihood of obtaining a sufficient amount of dewatering to allow for eventual repurposing of the disposal area.

Further, the treated mixture may be storage stable after exiting the mixing apparatus, so as allow for improved processability and flexibility with respect to transportation. In exemplary embodiments, for a period of at least 100 hours after flowing the treated mixture from the mixing apparatus, the treated mixture is storage stable such that there is 1.5 wt % or less and/or 1.3% or less difference in solids content over the period of time of at least 100 hours. By 1.5 wt % (or 1.3%) or less difference in solids content it is meant that the difference in solids content of the treated slurry after leaving the mixing apparatus (approximately 0.01 hours) is 1.5 wt % (or 1.3%) or less as compared to the solids content of the treated slurry at least 100 hours after the treated mixture leaves the mixing apparatus (which solid content is based on the total weight of the treated mixture at the at least 100 hours after leaving the mixing apparatus). As such, when the delta in solids content at least 100 hours after leaving the mixing apparatus is 1.5 wt % (or 1.3%) or less, the treated mixture is determined to be storage stable. In exemplary embodiments, the treated mixture may be storage stable for a period of at least 50 hours after flowing the treated mixture from the mixing apparatus such that there is 1.2 wt % or less difference in solids content.

Further, for a period of at least 500 hours after flowing the treated mixture from the mixing apparatus, the treated mixture has a solids content that is at least 5.0 wt % greater over the period of time of at least 500 hours. By at least 5.0 wt % or greater difference in solids content it is meant that the difference in solids content of the treated slurry after leaving the mixing apparatus (approximately 0.01 hours) is 5.0 wt % or greater as compared to the solids content of the treated slurry at least 500 hours after the treated mixture leaves the mixing apparatus (which solid content is based on the total weight of the treated mixture at that time). As such, when the delta in solids content at least 500 hours after leaving the mixing apparatus is 5 wt % or greater, the treated mixture is determined to have sufficient dewatering effect that is not substantially delayed. In other words, a slight delay in dewatering is sought (e.g., within the first 100 hours to allow for transportation), though thereafter significant dewatering is sought such that dewatering is not substantially delayed.

Also, for a period of less than 10 hours after flowing the treated mixture from the mixing apparatus, the treated mixture may be storage stable such that there is 0.6 wt % or less difference in solids content. This is sought after, as it shows dewater is delayed for a short period of time.

### Flocculation Process and Flocculants

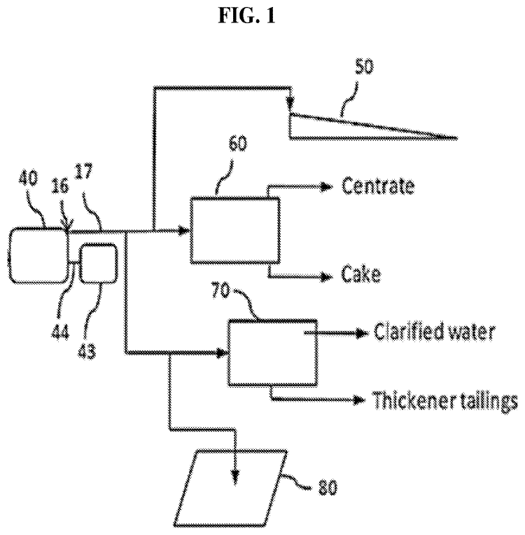

An exemplary flocculation process may include a feed line for the slurry (such as tailings from oil sands or mineral mines) to be pumped through a pipeline to the mixing apparatus 40 shown in FIG. 1. Water may be added to the slurry prior to being feed to the mixing apparatus 40 to adjust the solids content of the slurry. The liquid flocculants may be stored in tank 43 and fed to the mixing apparatus 40 through line 44. According to embodiments, the tank 43 allows for the direct addition of the liquid flocculants without pre-forming a solution or dispersion. The tank 43 may allow for lower operational costs as use thereof avoids the use of equipment for the formation and storage of hydrated flocculants. The treated mixture of the slurry and the flocculants may initially, and potentially for a period of at least 50 and/or at least 100 hours after leaving the mixing apparatus 40, have a low viscosity (e.g., less than 10,000 cP, less than 8,000 cP, less than 6,000 cP, less than 4,000 cP, etc.), as determined using a Brookfield DV3T viscometer with a V73 spindle at ambient conditions. The treated mixture may have a relatively stable viscosity for the period after leaving the mixing apparatus 40, such that formation of a high viscosity dough-like material may be minimized and/or avoided (for at least several hours after leaving the mixing apparatus 40). For example, if the dough-like mixture is formed, it may not be formed for at least 100 hours after leaving the mixing apparatus 40.

The outlet 16 of the mixing apparatus 40 flows into line 17. The internal diameter of pipe 17 may be the same, larger, or smaller than the internal diameter of the reactor outlet pipe 16. Once material has exited the mixing apparatus 40, it may be further treated and/or deposited in a deposition area.

Exemplary processes are described as follows, which may be used alone or in various combinations. In an exemplary embodiment, an in-line reactor (not shown) after the mixing apparatus 40 to further facilitate blending and interactions between the slurry and the flocculants. The in-line reactor may include one or more rotors and/or one or more stators. In an exemplary embodiment, the mixture may be transported to a thin lift sloped deposition site 50 (e.g., having a slope of 0.5% to 4% to allow water drainage). The water drainage may allow the material to dry at a more rapid rate and reach trafficability levels sooner. Additional layers can be added and allowed to drain accordingly. In another exemplary embodiment, the mixture is transferred to a centrifuge 60. A centrifuge cake solid containing the majority of the fines and a relatively clear centrate having low solids concentrations may be formed in the centrifuge 60. The centrifuge cake may then be transported, e.g., by trucks, and deposited in a drying cell. In another exemplary embodiment, the mixture is removed and placed in a thickener 70, which may produce clarified water and thickened tailings for further disposal. In another exemplary embodiment, the mixture is deposited at a controlled rate into an accelerated dewatering cell 80, e.g., a tailings pit, basin, dam, culvert, or pond, or the like which acts as a fluid containment structure. The containment structure may be filled with the mixture continuously or the mixture can be deposited in layers of varying thickness. The water released may be removed using pumps. The deposit fill rate may be such that maximum water is released during or just after deposition. Additional water may be released by the addition of an overburden layer to the deposited and chemically-treated tailings. Water release may be further facilitated by a process known as rim ditching where perimeter channels around the deposit are dug.

Through the process, the dewatered slurry may form a compact and dry solid mass through the actions of sedimentation, drainage, evaporative drying, and/or consolidation. The deposited particulate mineral material from the slurry may reach a substantially dry state.

An exemplary dewatering process for a slurry, such as tailings from oil sands, includes: (a) in a mixing apparatus according to embodiments mixing flocculants with the slurry to form a treated mixture; (b) allowing the mixture to flocculate; and (c) dewatering the treated mixture.

### Examples

Approximate properties, characters, parameters, etc., are provided below with respect to the illustrative working examples, comparative examples, and the information used in the reported results for the working and comparative examples.

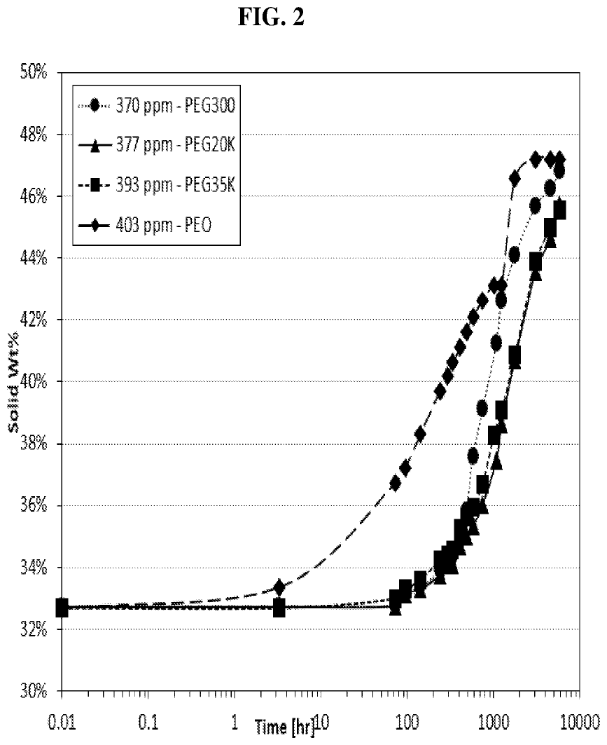

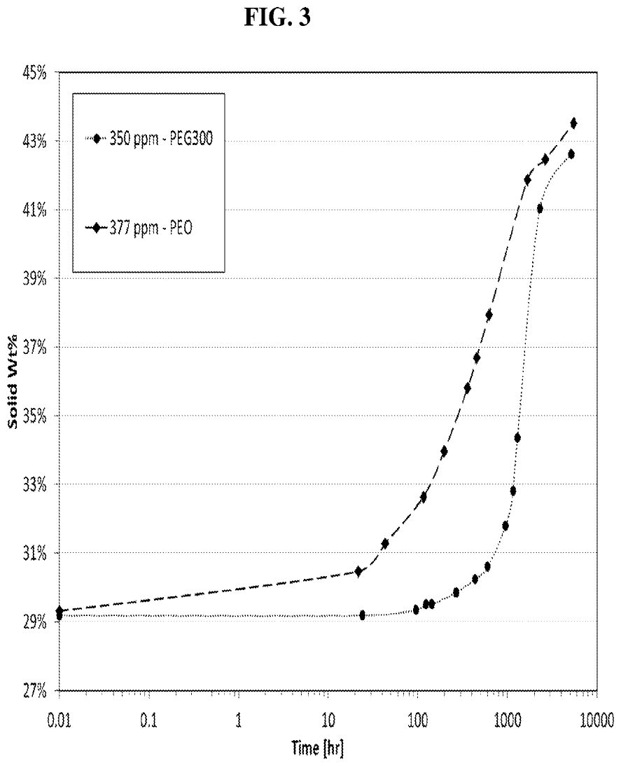

Referring to FIGS. 2 and 3, with respect to Working Examples 1 and 2 and Comparative Examples A, B, C, and D, the oil sands tailings are treated with a Flocculant Composition according to Tables 1 and 2, below.

Referring to the Tables the Flocculant Compositions are as Follows:

PEG300 is a mixture of water and CARBOWAX™ Polyethylene Glycol 300, which is a liquid polyethylene glycol at room temperature having a weight average molecular weight of approximately 300 g/mol available from Dow, Inc. The PEG 300 mixture is prepared by dilution of CARBOWAX™ Polyethylene Glycol 300 in process water to form a mixture of 0.4 wt % for comparison purposes, though CARBOWAX™ Polyethylene Glycol 300 may be used in an appropriate amount in its liquid form without dilution in water.

PEG20K is a solution of water and Polyethylene Glycol 20,000, which is solid flakes of polyethylene glycol at room temperature having a weight average molecular weight of approximately 20,000 g/mol available from Sigma Aldrich. The PEG 20K solution is prepared by solubilization in process water to form a solution of 0.4 wt %.

PEG35K is a solution of water and Polyethylene Glycol 35,000, which is solid flakes of polyethylene glycol having a weight average molecular weight of approximately 35,000 g/mol available from Sigma Aldrich. The PEG 35K solution is prepared by solubilization in process water to form a solution of 0.4 wt %.

PEO is a solution of water and a powder of POLYOX™ WSR-308, which is a water-soluble grade PEO resin having an number average molecular weight of approximately 8,000,000 Da polymer available from DuPont. The PEO solution is prepared by solubilization in process water to form a solution of 0.4 wt %.

The Examples in Table 1 are prepared using Tailings 1, which has an initial solids content of 32.7%, based on a total weight of the tailings (which includes solids and water).

TABLE 1

| | Working | Comparative | Comparative | Comparative |
|---|---|---|---|---|
| | Ex. 1 | Ex. A | Ex. B | Ex. C |
| Time | PEG300 | PEG20K | PEG35K | PEO |
| (hours) | (wt %) | (wt %) | (wt %) | (wt %) |
| 0 | 32.7% | 32.7% | 32.7% | 32.7% |
| 10 | 33.3% | 33.2% | 33.3% | 33.4% |
| 100 | 33.9% | 33.8% | 34.2% | 37.2% |
| 200 | 34.4% | 34.1% | 34.6% | 39.7% |
| 400 | 34.8% | 34.7% | 35.3% | 41.1% |
| 500 | 37.9% | 35.3% | 36.0% | 42.1% |
| 700 | 39.1% | 36.0% | 36.7% | 42.6% |
| 1000 | 41.2% | 37.5% | 38.3% | 43.1% |
| 3000 | 45.7% | 44.0% | 44.0% | 47.2% |
| 5000 | 46.8% | 45.7% | 45.5% | 47.2% |

The Examples in Table 2 are prepared using Tailings 2, which has an initial solids content of 29.2%.

TABLE 2

| | Working | Comparative |
|---|---|---|
| | Ex. 2 | Ex. D |
| Time | PEG300 | PEO |
| (hours) | (wt %) | (wt %) |
| 0 | 29.2% | 29.3% |
| 10 | 29.2% | 30.5% |
| 100 | 29.3% | 32.6% |
| 200 | 29.9% | 34.0% |
| 400 | 30.2% | 36.7% |
| 600 | 30.6% | 37.9% |
| 1000 | 31.8% | 41.9% |
| 3000 | 41.5% | 41.6% |
| 5000 | 42.6% | 43.5% |

To prepare Working Example 1 and Comparative Examples A to C, a HPLC pump is used to individually fed each Flocculant Composition into a stream of the Tailings 1 flowing through a progressive cavity pump. Upon exiting the second pump, the mixture flows through a static mixer before collecting into 100 mL graduated cylinders. The flow rate of the tailings is controlled using a progressive cavity pump from SEEPEX (SEEPEX MD 0015-24) equipped with a stainless steel rotor. The Flocculant Composition is delivered with a HPLC pump from Gilson (Gilson 305) equipped with a 10 SC pump head that allows for the dosages to be evaluated. In particular, referring to FIG. 2, the dosage is 370 ppm for Working Example 1, 377 ppm for Comparative Example A, 393 ppm for Comparative Example B, and 403 for Comparative Example C. The dosage is determined based on the solids content in the tailings stream and flocculant content in the mixture/solution (in other words based on the content of the PEG or PEO material present and not the total amount of mixture/solution added). After treatment, the samples are collected in 100 mL graduated cylinders and stored for monitoring of dewatering. Examples are left to settle for a period over 5000 hours and the solids content over time is shown in FIG. 2.

To prepare Working Example 2 and Comparative Example D, a progressive cavity pump is used to fed the flocculant solution (0.4 wt %) into a stream of the Tailings 2 flowing through a second progressive cavity pump. Upon exiting the second pump the mixture flows through a static mixer before collecting into 5 gallon containers. The flow rate of the tailings is controlled (10 gpm) using a progressive cavity pump from SEEPEX (SEEPEX BN5). The flocculant is delivered with a progressive cavity pump from SEEPEX (SEEPEX MDP-12) that allows for the dosages to be evaluated. In particular, referring to FIG. 3, the dosage is 350 ppm for Working Example 2 and 377 ppm for Comparative Example D. The dosage is determined based solids content in the tailings stream and flocculant content in the mixture/solution. After treatment the samples are collected in 5 gallon containers and stored for monitoring of dewatering. Examples are left to settle for a period over 5000 hours and the solids content over time is shown in FIG. 3.

Referring to FIG. 2, it is shown that Working Example 1 allows for a higher overall solids content in shorter period of, as compared to Comparative Examples A and B. Further, it is shown that Working Example 1, as compared to Comparative Example C, allows for significantly improved storage stability. For example, referring to FIG. 2, it is seen that for a period of at least 100 hours after mixing, the solids content is relatively stable for Working Example 1. In contrast, Comparative Example C shows a relatively high change in solids content over that period. Further, it is shown that while the solids content only reaches approximately 46 wt % for Working Examples 1 over the 5000 hour time period, Working Example 1 does not demonstrate a plateau effect with respect to solids content as compared to Comparative Example C. Accordingly, it is believed a higher final solids content may be achieved for at least Working Example 1 over a longer period of time.

Similarly, referring to FIG. 3, it is shown that Working Example 2 allows for significantly improved storage stability as compared to Comparative Example D. In particular, referring to FIG. 3, it is seen that for a period of at least 100 hours after mixing, the solids content is relatively stable for Examples 2 and 3. In contrast, Comparative Example D shows a relatively high change in solids content over that period.

1. A continuous process for treating tailings, the process comprising:
providing tailings for treatment having at least 10 wt % solids, based on a total weight of the tailings;
providing a mixing apparatus having a first inlet for feeding the tailings, a second inlet for feeding a non-dispersion liquid flocculant that includes a polyethylene glycol having a weight average molecular weight from 100 g/mol to 2,000 g/mol, and an outlet for a mixture of the tailings and the non-dispersion liquid flocculant;
continuously introducing into the mixing apparatus the tailings through the first inlet and the non-dispersion liquid flocculant through the second inlet;
allowing the tailings and the non-dispersion liquid flocculant to mix to form the mixture of the tailings and the non-dispersion liquid flocculant;
continuously removing the mixture of the tailings and non-dispersion liquid flocculant through the outlet to form a treated mixture; and
flowing the treated mixture from the mixing apparatus for further treatment or to a disposal area.

2. The process as claimed in claim 1, wherein the non-dispersion liquid flocculant excludes any hydrated solid flocculants.

3. The process as claimed in claim 1, wherein the non-dispersion liquid flocculant excludes any poly(ethylene oxide)(co)polymer that has a number average molecular weight of at least 100,000 Da.

4. The process as claimed in claim 1, wherein the weight average molecular weight of the polyethylene glycol is from 100 g/mol to 700 g/mol.

5. The process as claimed in claim 1, wherein the non-dispersion liquid flocculant consists essentially of the polyethylene glycol and optionally water.

6. The process as claimed in claim 1, wherein:
for a period of less than 100 hours after flowing the treated mixture from the mixing apparatus, the treated mixture is storage stable such that there is 1.5 wt % or less difference in solids content, and
for a period of at least 500 hours after flowing the treated mixture from the mixing apparatus, the treated mixture has a difference in solids content that is 5 wt % or greater.

7. The process as claimed in claim 1, wherein for a period of less than 10 hours after flowing the treated mixture from the mixing apparatus, the treated mixture is storage stable such that there is 0.6 wt % or less difference in solids content.

8. The process as claimed in claim 1, wherein the treated mixture is flowed from the mixing apparatus to further treatment in a centrifuge, thickener, or accelerated dewatering cell and then is flowed from the centrifuge, thickener, or accelerated dewatering cell to the disposal area.

9. The process as claimed in claim 1, wherein the tailings are oil sands tailings.

10. Treated tailings from oil sands, the tailings being treated according to the process as claimed in claim 1.
